(19) United States
(12) Patent Application Publication
(10) Pub. No.: US 2011/0321030 A1
(43) Pub. Date: Dec. 29, 2011

(54) METHOD AND APPARATUS FOR UPDATING A SOFTWARE IMAGE

(75) Inventors: Rajeswari Rajan, Bangalore (IN); Lars Kurth, London (GB)

(73) Assignee: NOKIA CORPORATION, Espoo (FI)

(21) Appl. No.: 13/120,525

(22) PCT Filed: Sep. 22, 2009
(86) PCT No.: PCT/IB2009/054145

§ 371 Date: May 24, 2011

(30) Foreign Application Priority Data
Sep. 24, 2008 (GB) 0817514.3

(51) Int. Cl. G06F 9/445

(52) U.S. Cl. 717/170

(57) ABSTRACT

A method and apparatus for updating the software image on a plurality of computing devices which comprises creating a simulated version of the software image of the devices in a changed format, altering the simulated version of the software image and copying the altered version back to the devices. The change of format typically obviates the need for human interaction during the update process.

### TECHNICAL FIELD

Embodiments of the invention relate to the installation of software and, in particular, software for a computing device such as a mobile phone.

### BACKGROUND TO EXAMPLE EMBODIMENTS OF THE INVENTION

Certain computing devices have hardware configurations, operating systems and software applications which are determined prior to manufacture. These devices are then mass-produced according to the configurations and during the software installation process the software needed for the device is compiled and the resultant software collection, in the form of a ROM image, is copied to the mass-produced devices ensuring that each device has the same software.

### SUMMARY OF EXAMPLE EMBODIMENTS OF THE INVENTION

According to a first aspect, certain embodiments of the invention provide for a method comprising:
producing a simulated version of a software image for a first computing device on a second computing device;
altering said simulated version of said software image according to one or more installation instructions; and
installing said altered simulated version of said software image on a plurality of further computing devices, each being similar to said first computing device; wherein,
producing said simulated version of said software image comprises changing a format of said software image.

In certain embodiments, changing said format of said software image may comprise changing access rights to said software image. Changing said format of said software image may comprise changing said format from a format which requires user interaction to operate said installation instructions to a format which does not require user interaction to operate said installation instructions.

Changing said format of said software image may be carried out when said simulated version of said software image is produced on said second computing device.

The installation instructions may correspond to instructions for installing software. The software may, for example, be an update to a software program contained in said software image or may relate to new software. In an embodiment, the installation instructions correspond to instructions for installing a plurality of applications.

The installation instructions may correspond to a software installation package for installing said software. In this case, altering said simulated version of said software image may comprise translating instructions issued by said software installation package into said installation instructions.

Altering said simulated version of said software image may comprise translating instructions issued by one or more software installation packages.

Altering said simulated version of said software image according to one or more installation instructions may comprise logging installation instructions for a plurality of applications having one or more dependencies and verifying said dependencies prior to altering said simulated version of said software image.

Verifying said dependencies may comprise determining a set of dependent function collections for said applications and ensuring that said altered simulated version of said software image may include said set of dependent function collections.

The dependent function collections may be dynamic link libraries.

Installing said altered simulated version of said software image on said first computing device may comprise converting said simulated version of said software image to any one of a FAT16, FAT32 or Ruggedized FAT file systems.

Installing said altered simulated version of said software image on said first computing device may comprise copying said image directly to a non-volatile memory for use with one of said plurality of devices.

Altering said simulated software image may be carried out on said second computing device.

An operating system of said first computing device may be different from an operating system of said second computing device.

A further embodiment of the invention relates to an apparatus comprising:
a processor,
memory including computer program code,
the memory and the computer program code configured to, with the processor, cause the apparatus at least to perform:
   producing a simulated version of a software image for a first computing device on a second computing device;
   altering said simulated version of said software image according to one or more installation instructions; and
   installing said altered simulated version of said software image on a plurality of further computing devices, each being similar to said first computing device; wherein,
   producing said simulated version of said software image comprises changing a format of said software image.

Changing said format of said software image may comprise changing access rights to said software image.

Changing said format of said software image may comprise changing said format from a format which requires user interaction to operate said installation instructions to a format which does not require user interaction to operate said installation instructions.

Changing said format of said software image may be carried out when said simulated version of said software image is produced on said second computing device.

The installation instructions may correspond to instructions for installing software.

The installation instructions may correspond to a software installation package for installing said software.

Altering said simulated version of said software image may comprise translating instructions issued by said software installation package into said installation instructions.

Altering said simulated version of said software image may comprise translating instructions issued by one or more software installation packages.

Altering said simulated version of said software image according to one or more installation instructions may comprise logging installation instructions for a plurality of applications having one or more dependencies and verifying said dependencies prior to altering said simulated version of said software image.

Verifying said dependencies may comprise determining a set of dependent function collections for said applications and ensuring that said altered simulated version of said software image includes said set of dependent function collections.

The dependent function collections may be dynamic link libraries.

Installing said altered simulated version of said software image on said first computing device may comprise converting said simulated version of said software image to any one of a FAT16, FAT32 or Ruggedized FAT file systems.

Installing said altered simulated version of said software image on said first computing device may comprise copying said image directly to a non-volatile memory for use with one of said plurality of devices.

Altering said simulated software image may be carried out on said second computing device.

An operating system of said first computing device may be different from an operating system of said second computing device.

A further embodiment of the invention relates to a computer readable medium storing instructions, said instructions being such that when processed by a processor configure said processor to:
produce a simulated version of a software image for a first computing device on a second computing device;
alter said simulated version of said software image according to one or more installation instructions; and
install said altered simulated version of said software image on a plurality of further computing devices, each being similar to said first computing device; wherein,
producing said simulated version of said software image comprises changing a format of said software image.

A further embodiment of the invention relates to an apparatus comprising:
a processor,
memory including computer program code,
the memory and the computer program code configured to, with the processor, cause the apparatus at least to perform:
   producing a simulated version of a software image for a computing device on the apparatus;
   altering said simulated version of said software image according to one or more installation instructions; and
   installing said altered simulated version of said software image on a plurality of further computing devices, each being similar to said first computing device; wherein,
   producing said simulated version of said software image comprises changing a format of said software image.

The computing device may be a mobile phone configured to operate the Symbian® operating system.

In an embodiment, installing the altered simulated version of the software image on the first computing device comprises copying the image to a non-volatile memory of the device or devices. The non-volatile memory may, e.g., be a flash drive. This may comprise converting the format of the image back to the format of the image of the first computing device.

Installing the altered simulated version of the software image on the first computing device may comprise updating data stores on the device wherein the data stores hold security related information. The data stores may hold certificates and/or encryption key registers.

In an embodiment, the updated image may be communicated directly to a memory for a mobile device.

### BRIEF DESCRIPTION OF THE DRAWINGS

Embodiments of the invention are hereinafter described with reference to the accompanying diagrams where like numerals are used to refer to like components and where:

FIG. 1 is a schematic diagram of a mobile computing device in which an embodiment of the invention has been implemented;

FIG. 2 is a schematic representation showing the arrangement of certain of the hardware components of the device of FIG. 1;

FIG. 3 is a block diagram representing the mobile computing device of FIG. 1;

FIG. 4 is a schematic representation of the flash drive of FIG. 3;

FIG. 5 is a schematic representation of a portion of the flash drive illustrated in FIG. 4;

FIG. 6 depicts a network of computing devices suitable for implementing an embodiment of the invention;

FIG. 7 is a process diagram illustrating an embodiment of the invention; and

FIG. 8 is a schematic diagram illustrating interactions between data collections and software applications according to an embodiment of the invention.

### DESCRIPTION OF EXAMPLE EMBODIMENTS

In a situation where the software for the device is produced at one location by a software producer in the form of an image and then transmitted to the hardware manufacturer for installation on the devices, the hardware manufacturer may wish to alter the software compiled by the software producer. This may occur for any number of reasons such as, for example, a late change in the hardware by the hardware manufacturer.

The production of the software image may involve information which the software producer does not wish to divulge to third parties. Therefore the software producer may be unwilling to provide the hardware manufacturer with sufficient information to allow the hardware manufacturer to produce the ROM image.

The only alternative previously known way for the hardware manufacturer to install an update to the software on the mass-produced device is to do so by installing the update on each individual device. This utilises the same procedures and software a user of the device would employ to install the updated software on their device. For example, under the Symbian® operating system this takes advantage of the SIS file system and corresponding installation software. Similar arrangements exist under other operating systems.

In a known automated process, devices to be upgraded are upgraded by means of a production line. The production line would include the following steps for each device which is to be upgraded: firstly, an installation package with the required software upgrade is produced and copied to each device; the installation package is then operated on the device to upgrade the software of that device. A software agent may be installed on the device to simulate user interaction, thereby avoiding the necessity of having a user input the required data to the installation package for each device.

However, it is time consuming for a hardware manufacturer to repeat the process for each device concerned. Furthermore, the software application installation process for many devices severely limits the access provided to a user when installing software (as a security feature). These limitations can often bar a hardware manufacturer from installing the required software update and heretofore the only recourse was for the hardware manufacturer to then negotiate with the software provider to include the requisite software upgrade in the software they produce.

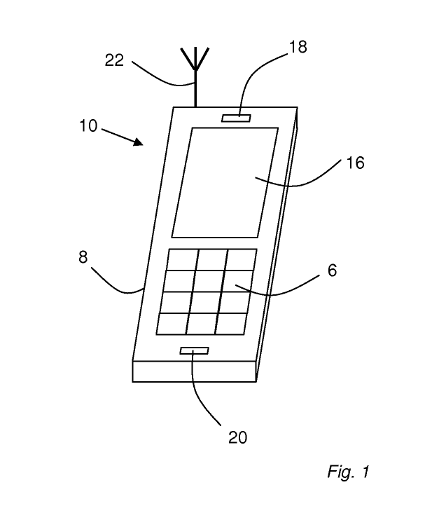

FIG. 1 is a schematic diagram of a mobile computing device 10 having a casing 8. The casing 8 encapsulates a keypad 6, a screen 16, a speaker 18 and a microphone 20. The device 10 further includes an antenna 22. The mobile computing device 10 illustrated in FIG. 1 may function as a phone and, in this instance, sends and receives telecommunication signals via antenna 22. Mobile phones such as computing device 10 are commonly sold as “smart phones” and are well known in the art.

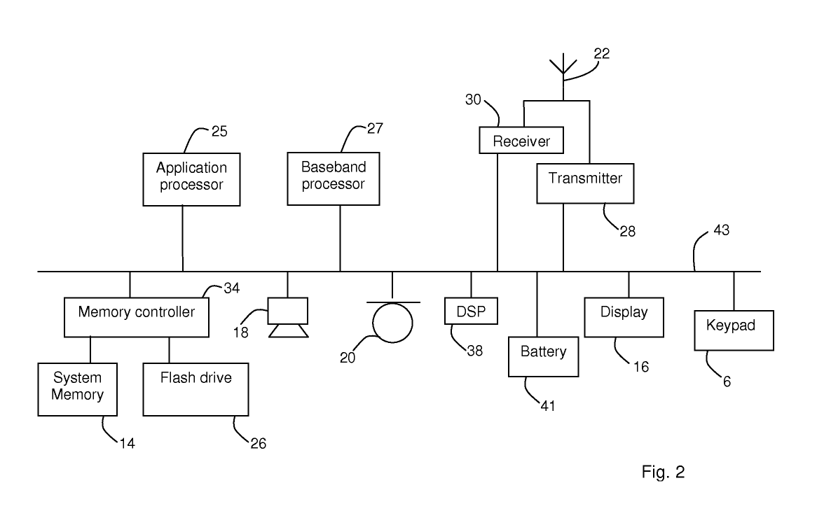

FIG. 2 is a schematic illustration showing the arrangement of certain of the hardware components of the device 10 of FIG. 1. The keypad 6, display 16, speaker 18 and microphone 20 are connected to a system bus 43. The bus 43 is further connected to an application processor 25, a baseband processor 27, a digital signal processor (DSP) 38, a transmitter 28, a receiver 30 and a battery 41. Transmitter 28 and receiver 30 are connected to antenna 22. The bus 43 is further connected to a memory controller 34 which is, in turn, connected to a system memory 14 and a flash drive 26. The application processor 25 processes instructions related to various software modules and operating system software which run on the device 10 and which provide various functionality of the device 10. The baseband processor 27 is concerned with the communication functions and to this end controls a telephony stack and communicates with the transmitter 28 and receiver 30 to establish communications by means of the antenna 22. The various processing elements of the device 10 such as the application processor 25 and baseband processor 27 may, in an alternate embodiment, be provided on a single processor.

Memory controller 34 controls the access to, and interaction with, system memory 14 and flash drive 26. The application processor 25 is able to communicate with the various hardware elements as well as the memory controller 34 and thereby control the operation of the various hardware elements according to software instructions stored on system memory 14 or flash drive 26.

Only a single bus, bus 43, is illustrated in FIG. 2. It is to be realised that this bus may be replaced by two or more buses and that the topology of FIG. 2 would vary accordingly. Furthermore, known computing devices include hardware components additional to those illustrated in FIG. 2, but these are well known in the art and are not further described or illustrated herein.

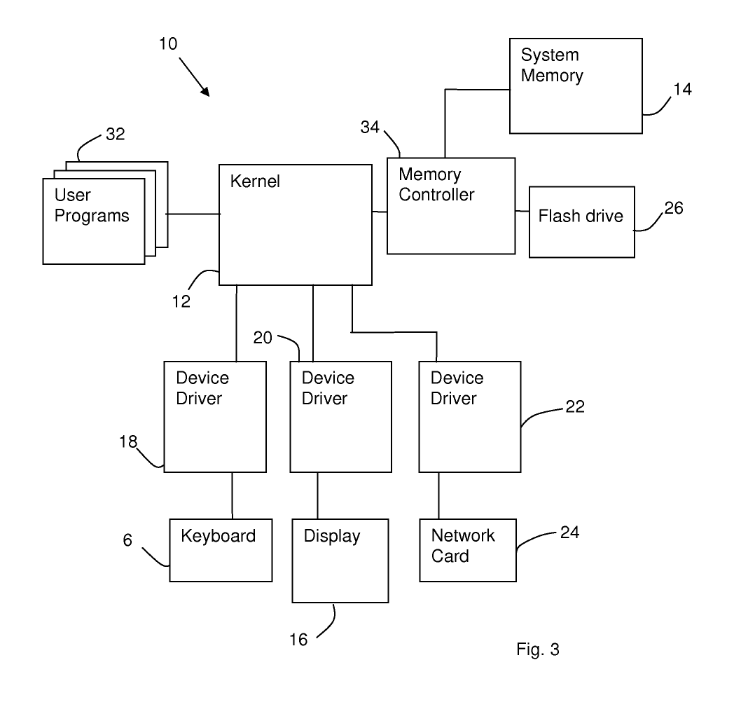

FIG. 3 is a schematic illustration of certain components of the mobile computing device 10. Device 10 includes a kernel 12 which schematically represents the operating system of the device 10. The kernel 12 is connected to system memory 14 which is controlled by means of a memory device driver 34. In this embodiment, the system memory 14 is the ROM of the device 10. Device 10 further comprises a flash drive 26 connected to the memory device driver 34. The flash drive 26 stores all the information for the device 10 when power is not available. This flash drive 26 is divided into a ROM drive, a read only file system (ROFS) and a user data area, in a known manner and as hereinafter described.

Additional device drivers 18, 20 and 22 are connected to the kernel 12 and control the behaviour of, and communication with, further respective devices: keypad 6, display 16 and network card 24. Although the device drivers are illustrated as being connected to kernel 12, it is to be realised that in certain situations, these device drivers could be considered part of the kernel 12, depending on the type of device driver. It is further to be realised that the mobile computing device 10 includes many more devices and components than those illustrated here. Mobile computing devices in many forms are known in the art and will therefore not be further described herein.

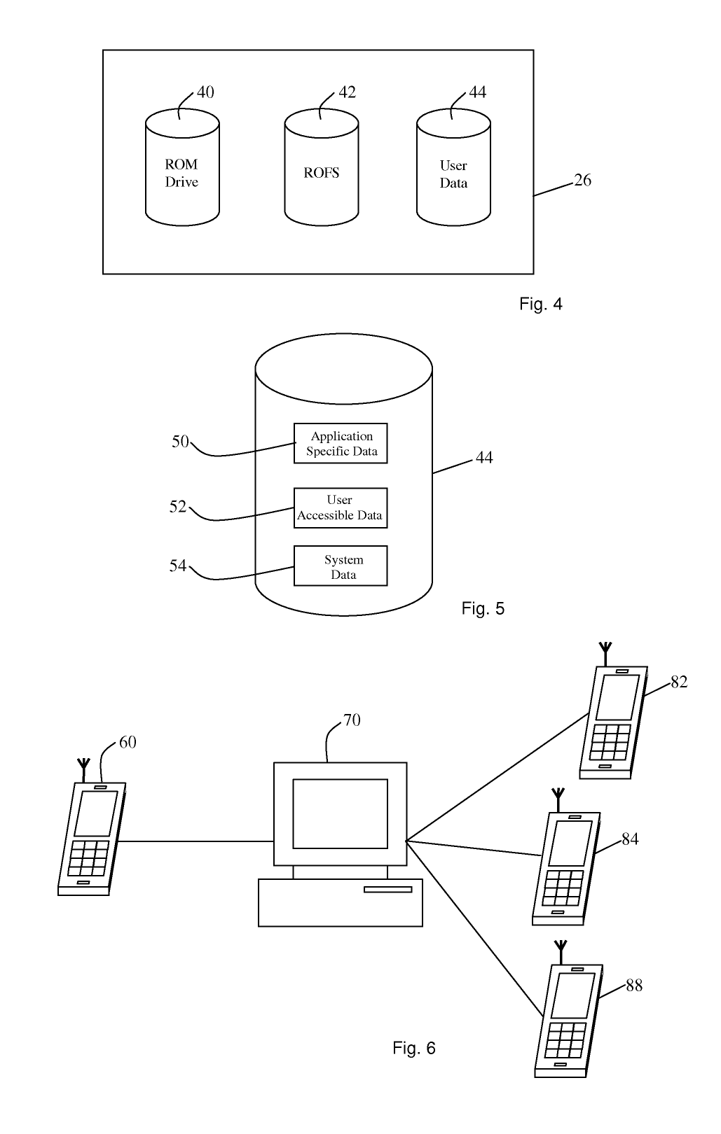

As previously mentioned, the flash drive 26 includes subdivisions. FIG. 4 shows the flash drive 26 with ROM drive 40, ROFS 42 and user data area 44. It is to be realised that in practice the flash drive 26 includes other data not shown in FIG. 4. For example, the flash drive 26 may include a boot loader, partition information, language pack image and a core OS image in a compressed format. What is important in the present circumstances is the realisation that all of the software components illustrated in FIG. 3 (such as the kernel 12, user programs 33 and device drivers 18, 20 and 22) are established from the data stored on the flash drive 26 when the device 10 boots up.

Once the device 10 is operational, the portion of the flash drive representing the ROM drive 40 and ROFS 42 will be stored in the system memory 14 illustrated in FIG. 3 whereas the user data area 44 will be accessed from the flash drive 26. The ROM drive 40 and the ROFS 42 remain relatively unchanged over the lifetime of the device 10. On the other hand the user data area 44 stores application data as well as data created and accessed by a user of the device 10.

FIG. 5 illustrates the user data 44 of FIG. 4. As illustrated, the user data 44 is subdivided into application specific data 50, user accessible data 52 and system data 54 (although it is to be realised that the illustrated division is not representative of all computing devices to which embodiments of the invention might apply, but merely presented by way of example). The application specific data 50 stores data used by the user programs 32 illustrated in FIG. 3. This application specific data includes an executable file which dictates the manner in which the corresponding application operates once the application is launched. The user accessible data 52 includes data which a user of the device 10 is capable of accessing, changing and deleting. Typically, this includes documents and media files created by the user. The system data 54 includes data used by the operating system to organise the device 10. For example, this will include a registry to determine which of the applications are loaded on start up as well as storing any parameters for the application set by a user. These divisions of the storage space are known in the prior art and will therefore not be further described herein. In the context of the present invention it is important to realise that the data on the flash drive 26 (non-volatile memory) is used, in conjunction with the hardware devices illustrated in FIG. 1, to dictate the behaviour and capabilities of the device 10. Therefore, to change the manner in which the device operates, it is necessary to change the data stored on the flash drive 26. Furthermore, if any of the hardware devices illustrated in FIG. 1 change, it is generally necessary to change the data stored on the flash drive 26 to enable the device to interact with the new hardware (for example, by providing an updated, replacement device driver for the new hardware component).

Computing devices such as mobile phones are, as previously mentioned, mass produced. Therefore, the data on the flash drive 26 for each device when it is sold will be the same. Under these circumstances, a ROM image is produced and this is copied (in a process often referred to as “flashing”) to each similar device. Once this has been done the data on flash drive 26 may be updated in an individual device by means of an installation package. Such an installation package contains instructions for updating the data on flash drive 26 so that a new or updated software package is installed. Typically, this would involve updating the application specific data 50, the user accessible data 52 and the system data 54 (although it is to be realised that this will depend on the particular installation package involved and it is not necessary for each of the data types to be updated). Under the Symbian® operating system the instructions for updating data and the corresponding data to be copied are provided as an installation package provided as an SIS file.

As previously discussed, embodiments in the invention find a particular application to the situation where it is desirable to update the contents of a flash drive (for example) for a number of similar devices.

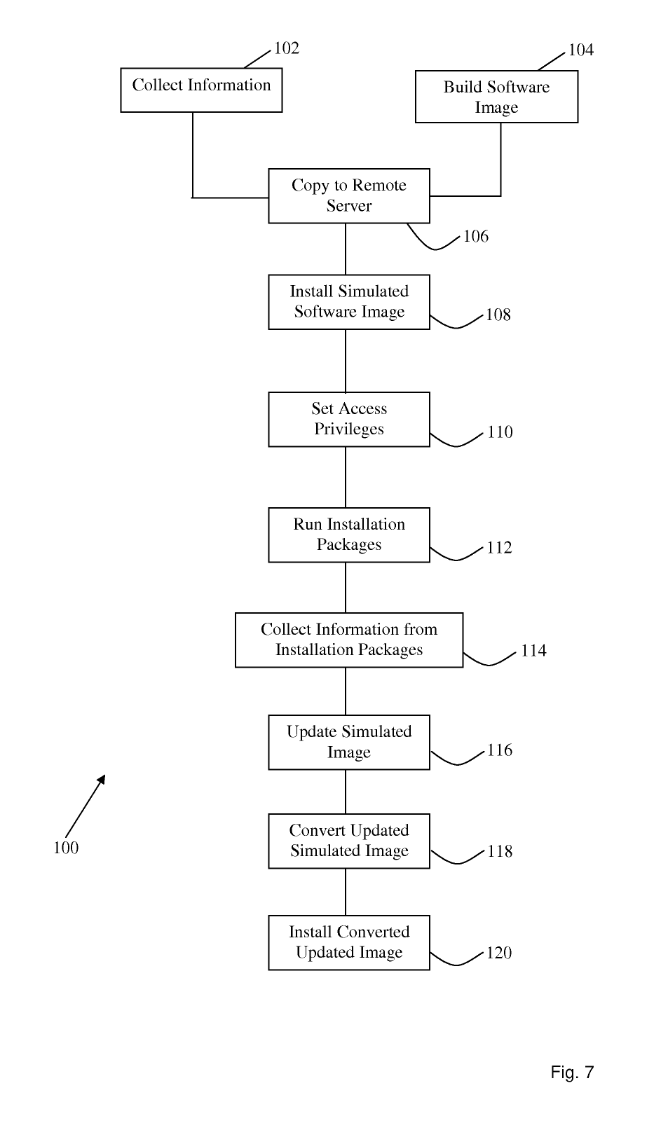

FIG. 6 illustrates a network of computing devices in which embodiments of the invention may be implemented. Computing device 60 is a smartphone similar to the device 10 illustrated in FIGS. 1 and 3. Computing device 60 is connected to a server 70. The server 70 is used to update the software of the computing device 60 in a manner described below. As illustrated, server 70 is further connected to mobile computing devices 82, 84 and 88. Mobile computing devices 82, 84 and 88 are similar to device 60 and their connection to server allows the server 70 to update the software on these computing devices. Although a connection between server 70 and only three further computing devices 82, 84 and 88 has been shown, it is to be realised that in practice many more of such devices may be connected to the server 70. Each of the mobile computing devices 60, 82, 84 and 88 has a data collection similar to that of the flash drive 26 illustrated in FIG. 4 provided on their flash devices. The computing devices 60, 82, 84 and 88 are manufactured by a device manufacturer whereas, in the embodiment illustrated, the software operating on these devices is produced elsewhere and compiled into a software image which is installed on each of these devices. The software could be produced at any one of a number of locations and then compiled at a single location. In this embodiment, the software is compiled into an image where the operating system portions of the software are produced. The image is then sent to the hardware producer who will install the image on each of the devices 60, 82, 84 and 88. Then, when this software is to be updated, the devices are connected to the server 70 in the manner illustrated in FIG. 6. FIG. 7 illustrates a process 100 for updating the software in computing device 60 and installing the updated software in mobile computing devices 82, 84 and 88 (FIG. 6). The process can be initiated in one or two ways. In block 102, information is collected from the computing device 60. This comprises determining the manner in which data stored in flash drive 26 is utilised during operation of the device (i.e. determining which of the data is application specific data, user accessible data and system data, as described above with reference to FIG. 5). The portion of the process may involve reverse engineering an existing device by determining where and how the data is stored and stipulating this in an appropriate manner. Alternatively, the process may be initiated at block 104 in which the software image (corresponding to the data collection on the flash drive 26) is built according to a known process. Block 104 represents the portion of the process normally undertaken by a manufacturer of a computing device. Both blocks 102 and 104 will result in a specification for the data collection of the computing device 60. The resulting specification can be used to write all of the required data to the flash drive 26 (FIG. 4). Data is copied to server 70 so that it may be accessed without the security-related applications which would be operational if the data were accessed on the mobile device 60 interfering with the access.

In the next following block 106, the information collected or generated in blocks 102 and 104 is copied to the server 70 (FIG. 6). Then, on server 70, the copied data is installed as a simulated software image. The simulated software image is a representation of the data on the flash drive of device 60 which is resident on the server 70. The simulated software image will include the corresponding directory structure, files and any other data contained in the flash drive of the mobile device 60.

A simulated software image operating on a computing device other than the mobile device for which it was intended may be accessed without the interference of security-related applications which may, at the very least, require some form of user interaction to install the software. The security-related applications may, in other instances, prevent the installation of the software where, for example, the installation attempts to make prohibited changes.

Such access control is necessary in the usual operating environment of the mobile device where potentially anyone has access to the device and the likelihood that malicious software such as viruses are installed on the device is increased. However, such security safeguards are not required when the software is installed in a controlled environment e.g. by a hardware manufacturer at a secured factory.

Therefore, by producing a simulated version of the software image on a computing device different from the device on which the software image operates, certain embodiments of the invention allow an updated software image to be produced without the need for the interactivity normally required (by either a user or a software agent). The mass installation of the software upgrade is therefore significantly simplified and may be performed quicker than previously known installation methods.

In block 110, the format of the simulated software image is changed by setting access privileges for the simulated software image on the server 70. During this portion of the process, it is verified that all of the parts of the simulated software image which may need to be changed are accessible. This will depend on the details of the simulated software image involved, and may, for example, include ensuring that the correct directories have read, write and modify rights for a user of the server 70.

Changing the format of the software image when the simulated software image is produced ensures that it is possible to set the user access rights to the simulated software image in such a way that the simulated software image may be altered according to said installation instruction. This avoids the problems encountered when insufficient user rights are granted to allow the update of specific software in the software image. Changing the access rights may allow the installation instructions to operate on the simulated software image on a second computing device where not permitted on a first computing device.

It is to be realised that in further embodiments the format of the simulated software image may include changes as an alternative to, or in addition to, changing access rights. In the further embodiments the format may be changed from a format which requires user interaction to update the simulated software image to a format which does not require user interaction to update the simulated software image. By obviating the need for user interactions, certain embodiments of the invention avoid the need for a user or software agent to oversee the installation of a software update for each device to be updated thereby significantly simplifying the process.

In further embodiments, the format may be changed by changing a file system of the simulated software image. This facilitates changing the image.

In the following block, block 112, the installation packages for the updated software are run. For the purposes of this embodiment, it is assumed that the updated software has a corresponding installation package. It will be realised that the server 70 is a substantially different environment to the device 60. Therefore block 112 involves simulating the environment of the data of the device 60 so that the installation package (which was designed to operate on device 60) can be run on server 70 and thereby update the simulated software image stored on the server.

In an alternative embodiment, block 112 is optional and the process will proceed directly to block 114 from block 110.

Then in block 114, the information generated by the running of the installation package in block 112 is collected. This information will generally record the changes caused by the running of the installation package. For example, this will record where new data is written and where previous data is changed or deleted. For this reason, it is important that the correct access privileges are set in block 110. If the installation package does not have the correct access privileges when run, it will not be able to institute the correct changes and therefore the recordal (at block 114) will not be successful. However, the setting of the access privileges at block 110 may be an implicit portion of the process at least in that under certain operating systems it can be safely assumed that a user running the installation package will have full access rights to the data written to the server 70 in block 106.

Block 114 includes a process of translation to ensure that the installation instructions which would modify the flash drive of mobile device 60 would apply to the simulated software image. This translation process will depend on the implementation of the simulated software image on the server 70, but will, for example, involve the alteration of directory names to conform to the directory structure of the simulated software image.

The installation or updating of software may be a simple process involving minimal changes to the flash drives of the devices to be updated. However, in certain circumstances, the update may be a complex process involving many applications which share functions through libraries. Such libraries give rise to dependency problems whereby a particular application will not operate as intended unless the libraries upon which that application is dependent have been installed.

Such dependencies between applications and libraries can also lead to problems where the libraries are out of date or incompatible with newer versions of the application.

Advantageously, block 114 involves collecting information regarding the changes to be made to the simulated software image. Where this involves many applications and shared libraries, the information collected here can be used to ensure that all the dependencies for the updated simulated software image are met and are met by the correct versions of the required libraries by keeping a log of all dependency requirements.

In block 116 the simulated image stored on the server 70 is updated. This portion of the process represents the action carried out by the installation package on the simulated software image stored on the server 70. The changes recorded in block 114 are, in this manner, applied to the simulated software image. In the following block, block 118, the now updated simulated image is converted back to the format required for installation on the mobile devices 82, 84, 88. The details of the conversion involved will depend on the manner in which the embodiment is implemented but may, for example, involve ensuring that the updated simulated image is formatted for the correct file system (for example FAT16, FAT32 or Ruggedized FAT). The file system will depend on the configuration of the mobile device which includes factors such as the operating system which the mobile device is configured to operate under.

Finally, in block 120 the updated software image is installed onto devices 82, 84 and 88. This generally includes uploading the new image to the flash drive of these mobile devices. Furthermore, the security-related data of the mobile device are updated with any pertinent information relating to the changes implemented by the installation package. This involves the updating of any certificate stores or key registers and other security-related information. In this manner the software in these devices has been updated. Advantageously, the same updated software image can be copied to each of the devices 82, 84 and 88 and, as can be seen, it was advantageously necessary to apply the update only once (to the software image on the server 70).

In certain embodiments, the updated image may be copied directly to a memory for a mobile device and this may occur before the memory is installed in the device. In the previously known methods of updating a software image it was necessary for the device to be fully assembled and operational before the updated image could be communicated to the memory of that device.

FIG. 7 illustrates a process according to which example embodiments in the invention may be implemented. However, it is to be realised that the implementation details will depend on many factors such as the type of the mobile devices 60, 82, 84 and 88, the operating systems involved, the manner in which the server 70 connects to the devices 60, 82, 84 and 88, in the operating system running on server 70 and the manner in which the data store (flash drives) of each of the devices is organised.

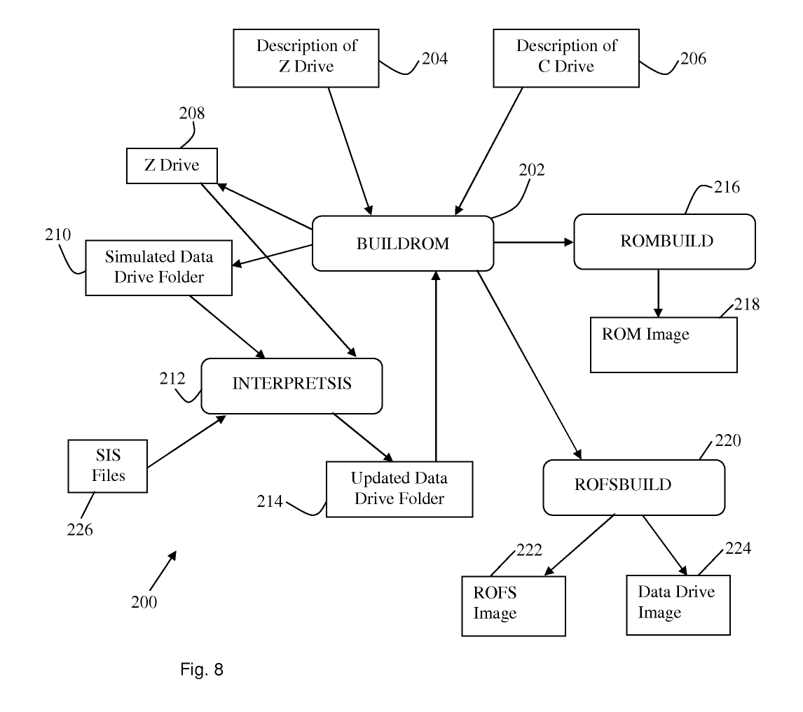

FIG. 8 is a schematic diagram illustrating the interaction between various software packages and data repositories for an implementation of an embodiment of the invention for mobile computing devices which operate the Symbian® operating system. FIG. 8 assumes that a pre-existing software image is to be updated. Under this implementation, the corresponding contents of a flash drive 26 is referred to as the “ROM Image”. The ROM Image consists of a Z drive and a C drive. The Z drive is the ROM drive 40 and ROFS 42 illustrated in FIG. 4 whereas the C drive is the user data 44. The C drive and Z drive are specified by IBY and OBY files in a known manner.

Referring to FIG. 8, the description of the Z drive 204 and the description of the C drive 206 comprise a collection of IBY and OBY files which serve to describe these data collections. BUILDROM 202 is an application which runs on the server 70 and which accepts the description of the Z drive 204 and the description of the C drive 206 and, from this, is capable of generating the Z drive 208. BUILDROM 202 is furthermore capable of using the input of the descriptions 204 and 206 to generate the simulated software image which is here represented by simulated data drive folder 210. With reference to the process of FIG. 7, the BUILDROM application 202 will therefore implement block 102 where the information of the software image is collected, block 106 where this information is copied to the remote server and block 108 where the software image is installed on the server.

Referring back to FIG. 8 a further application, INTERPRETSIS 212, is provided. INTERPRETSIS 212 takes the simulated data drive folder 210, Z drive 208 and SIS files 226 as inputs and produces an updated data drive folder 214. The SIS files 226 represent software, and, as previously described, these files specify the manner in which the data is to be changed for the update to the software. This corresponds to blocks 112, 114 and 116 of the process of FIG. 7.

Once the updated data drive folder 214 has been created, this is fed as an input into the BUILDROM application 202 which passes this information to a ROMBUILD application 216. ROMBUILD 216 then uses this information to generate an updated ROM Image 218. Similarly, the BUILDROM application 202 calls ROFSBUILD application 220 with the information from the updated data drive folder 214. The ROFSBUILD 220 will generate an updated ROFS Image 222 and an updated data drive image 224. This represents block 116 of the process of FIG. 7.

FIG. 8 illustrates the various applications involved in generating an updated software image. As hereinbefore described the applications BUILDROM 202, INTERPRETSIS 212, ROMBUILD 216 and ROFSBUILD 220 analyse the existing software image in the form of a description of the Z drive 204 and the description of the C drive 206 and, together with the stipulation of the updated software in the form of the SIS files 226 generate an updated software image (in the form of ROM image 218, ROFS image 222 and data drive image 224). It then remains to convert the updated image back to the former used by the mobile device (such as device 10) and install the updated software image on the requisite mobile devices. These would at least partially be completed by the NANDLOADER application. Other applications such as MAKESIS, CREATESIS, SIGNSIS and DUMPSIS may assist in the aforementioned process.

Referring back to FIG. 7, block 114 involves the collection of information from installation packages. In the embodiment illustrated in FIG. 8, this is carried out by the INTERPRETSIS application 212. The information relating to the software upgrade is contained in SIS files 226. The manner in which the update is to be specified can vary substantially from application to application. However, in a particular embodiment, the SIS files contain an executable file, a resource file and registry entries. INTERPRETSIS 212 would then install the executable file, the resource file and the registry entries in the corresponding locations in the simulated data drive folder 210 (FIG. 8). Therefore, when the BUILDROM application creates the simulated drive folder 210, this will be created with a directory structure corresponding to the software image contained on the device 60. Under known applications, these are specified by OBY and IBY files.

It will be understood by the skilled person that alternative implementations are possible, and that various modifications of the methods and implementations described above may be made within the scope of the invention, as defined by the appended claims. It should also be noted that any combination of the features and process elements described herein may be combined or omitted in different embodiments of the inventions.

A complete listing of the claims is as follows:

1. A method comprising:
producing a simulated version of a software image for a first computing device on a second computing device;
altering said simulated version of said software image according to one or more installation instructions; and
installing said altered simulated version of said software image on a plurality of further computing devices, each being similar to said first computing device; wherein,
producing said simulated version of said software image comprises changing a format of said software image.

2. The method according to claim 1 wherein changing said format of said software image comprises changing access rights to said software image.

3. The method according to claim 1 wherein changing said format of said software image comprises changing said format from a format which requires user interaction to operate said installation instructions to a format which does not require user interaction to operate said installation instructions.

4. The method according to claim 1 wherein changing said format of said software image is carried out when said simulated version of said software image is produced on said second computing device.

5. The method according to claim 1 wherein said installation instructions correspond to instructions for installing software.

6. The method according to claim 5 wherein said installation instructions correspond to a software installation package for installing said software.

7. The method according to claim 6 wherein altering said simulated version of said software image comprises translating instructions issued by said software installation package into said installation instructions.

8. The method according to claim 1 wherein altering said simulated version of said software image comprises translating instructions issued by one or more software installation packages.

9. The method according to claim 1 wherein altering said simulated version of said software image according to one or more installation instructions comprises logging installation instructions for a plurality of applications having one or more dependencies and verifying said dependencies prior to altering said simulated version of said software image.

10. The method according to claim 9 wherein verifying said dependencies comprises determining a set of dependent function collections for said applications and ensuring that said altered simulated version of said software image includes said set of dependent function collections.

11. The method according to claim 10 wherein said dependent function collections are dynamic link libraries.

12-13. (canceled)

14. The method according to claim 1 wherein altering said simulated software image is carried out on said second computing device.

15. The method according to claim 1 wherein an operating system of said first computing device is different from an operating system of said second computing device.

16. An apparatus comprising:
a processor,
memory including computer program code,
the memory and the computer program code configured to, with the processor, cause the apparatus at least to perform:
produce a simulated version of a software image for a first computing device on a second computing device;
alter said simulated version of said software image according to one or more installation instructions; and
install said altered simulated version of said software image on a plurality of further computing devices, each being similar to said first computing device; wherein,
produce said simulated version of said software image comprises changing a format of said software image.

17-19. (canceled)

20. The apparatus according to claim 14 wherein said installation instructions correspond to instructions for installing software. 21-22. Cancelled.

23. The apparatus according to claim 14 wherein alter said simulated version of said software image comprises translating instructions issued by one or more software installation packages.

24. The apparatus according to claim 14 wherein alter said simulated version of said software image according to one or more installation instructions comprises logging installation instructions for a plurality of applications having one or more dependencies and verifying said dependencies prior to alter said simulated version of said software image.

25-28. (canceled)

29. The apparatus according to claim 14 wherein alter said simulated software image is carried out on said second computing device.

30. The apparatus according to claim 14 wherein an operating system of said first computing device is different from an operating system of said second computing device.

31. A computer readable medium storing instructions, said instructions being such that when processed by a processor configure said processor to:
produce a simulated version of a software image for a first computing device on a second computing device;
alter said simulated version of said software image according to one or more installation instructions; and
install said altered simulated version of said software image on a plurality of further computing devices, each being similar to said first computing device; wherein,
producing said simulated version of said software image comprises changing a format of said software image.

32-33. (canceled)
